(19) United States
(12) Patent Application Publication
(10) Pub. No.: US 2007/0067951 A1
(43) Pub. Date: Mar. 29, 2007

(54) Method of manufacturing a cosmetic product applicator assembly and handle for cosmetic product applicator

(75) Inventor: Walter Dwyer, London (GB)

Correspondence Address: WILLIAM COLLARD;COLLARD & ROE, P.C., 1077 NORTHERN BOULEVARD, ROSLYN, NY, 11576, US

(73) Assignee: COSMOPAK INT. LTD.

(21) Appl. No.: 11/342,926

(22) Filed: Jan. 30, 2006

Related U.S. Application Data
(60) Provisional application No. 60/717,867, filed on Sep. 16, 2005.

(51) Int. Cl. E05B 1/00

(52) U.S. Cl. 16/110.1

(57) ABSTRACT

A method for manufacturing a cosmetic product applicator assembly includes selecting a disposable handle having a desired design from a number of handles of various designs. Each of the handles includes an elongated, decorative housing with a first end having an opening, a hollow chamber extending from the opening into the housing, and a flattened portion for displaying a word, phrase, symbol or design. A cosmetic product applicator having a first terminal end from which the cosmetic product is dispensed and a second terminal end opposite the first terminal end is inserted into the handle. The hollow chamber is adapted to receive and engage the second terminal end of the applicator in a non-rotatable manner.

### CROSS REFERENCE TO RELATED APPLICATIONS

This application claims the benefit of U.S. Provisional Application No. 60/717,867, filed Sep. 16, 2005.

### BACKGROUND OF THE INVENTION

1. Field of the Invention

The invention relates to a method for manufacturing a cosmetic applicator assembly and a handle for a cosmetic product applicator. More particularly, the invention relates to a handle for a cosmetic product applicator comprising an elongated, decorative housing having a hollow chamber for receiving and engaging a terminal end of a cosmetic product applicator. The housing may be produced in a variety of custom designs.

2. The Prior Art

The following references, the disclosure of which is hereby incorporated by reference, relate generally to housings for various writing implements: U.S. Pat. application Publication No. 2003/0235453 to Pearce; U.S. Pat. No. 4,030,841 to Balasty; U.S. Pat. No. 6,402,407 to Goldstein; U.S. Pat. No. 4,468,146 to Tabachnik; U.S. Pat. No. 5,468,083 to Chesar; and U.S. Pat. No. 1,438,114 to Hume.

The following references, the disclosure of which is hereby incorporated by reference, relate generally to various cosmetic product dispensing and/or storing devices: U.S. Pat. No. 3,358,699 to Bau; U.S. Pat. No. 5,836,708 to Tani; U.S. Pat. No. 4,987,911 to Powers; U.S. Pat. No. 6,718,990 to Chastain et al.; U.S. Pat. No. 6,237,613 to Finnigan; and U.S. Pat. No. 4,778,300 to French et al.; U.S. Design Pat. Nos. D443,104 to Coates et al.; D171,675 to Wisotsky and D147,514 to Strempel; and U.S. Pat. application Publication No. 2005/0178800 to Tani and U.S. Pat. No. 2005/0180805 to Sasaki.

### SUMMARY OF THE INVENTION

In a method for manufacturing a cosmetic product applicator assembly according to an embodiment of the invention, a handle having a desired design is selected from a plurality of handles of various designs. Each of the plurality of handles comprises an elongated, decorative housing with a first end having an opening and a hollow chamber extending from the opening into the housing. A cosmetic product applicator having a first terminal end from which the cosmetic product is dispensed and a second terminal end opposite the first terminal end is inserted into the handle. The hollow chamber of the handle is adapted to receive and engage the second terminal end of the applicator.

A handle for a cosmetic product applicator according to an embodiment of the invention comprises an elongated, decorative housing having a first end with an opening and a hollow chamber extending from the opening into the housing. The hollow chamber is adapted to receive and engage a terminal end of a cosmetic product applicator. The housing is produced in a variety of custom designs, each of the designs being compatible with a given applicator.

One benefit of a method and apparatus according to an embodiment of the invention is that a single cosmetic product applicator may be mated to a plurality of custom designed handles of various profiles and designs by providing an appropriately dimensioned chamber extending from an opening in one end of the handle and inserting the applicator into the chamber. Another benefit according to an embodiment of the invention is that a handle is provided with a flattened portion which is suitable for displaying various visible indicia which can be easily viewed by consumers.

### BRIEF DESCRIPTION OF THE DRAWINGS

Other benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a cutaway view of a cosmetic product applicator assembly manufactured according to an embodiment of the invention;

FIG. 2 shows an exploded perspective view of the cosmetic applicator assembly shown in FIG. 1;

FIG. 3 shows a perspective view of a handle for a cosmetic product applicator according to an embodiment of the invention;

FIG. 4 shows a perspective view of a handle for a cosmetic product applicator according to another embodiment of the invention;

FIG. 5 shows a perspective view of a handle for a cosmetic product applicator according to another embodiment of the invention;

FIG. 6 shows a perspective view of a handle for a cosmetic product applicator according to another embodiment of the invention;

FIG. 7 shows a perspective view of a handle for a cosmetic product applicator according to another embodiment of the invention; and

FIG. 8 shows a perspective view of a handle for a cosmetic product applicator according to another embodiment of the invention.

### DETAILED DESCRIPTION OF THE PREFERRED EMBODIMENT

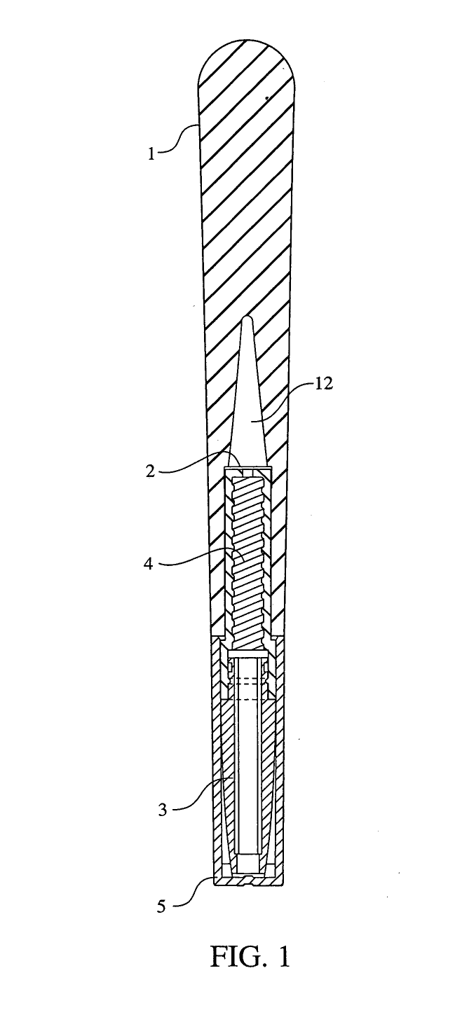

Referring now in detail to the drawings and, in particular, FIG. 1 shows a cutaway view of a cosmetic product applicator assembly manufactured according to an embodiment of the invention. As shown, the assembly may comprise a handle 1 and a cosmetic product applicator 2. Cosmetic product applicator 2 may comprise, for example, a mechanical pencil type applicator for advancing a length of solid cosmetic material such as an eyeliner or lip liner, or the like. Additionally, the applicator may comprise other types of devices for applying and/or dispensing a cosmetic material, such as, for example a cosmetic pencil or brush-type applicator.

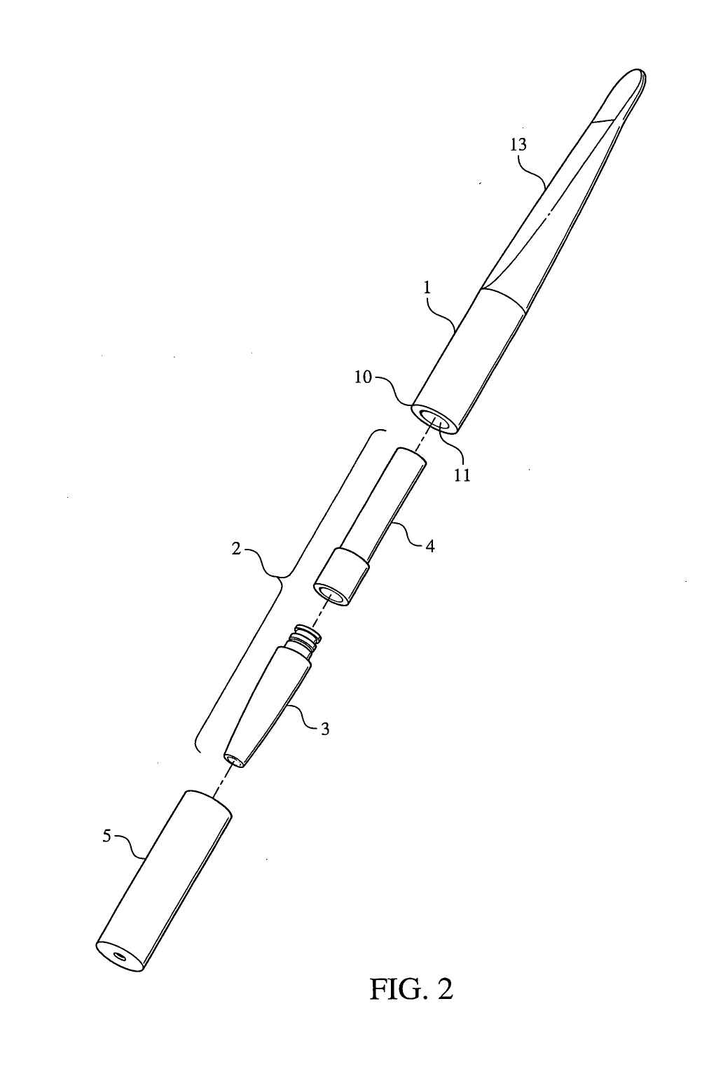

As shown, applicator 2 may include a tip portion 3 as well as an advancing mechanism 4. Tip portion 3 may have a first terminal end from which the cosmetic product is dispensed. This first terminal end may comprise an aperture as shown in FIGS. 1 and 2. Advancing mechanism 4 may comprise a mechanical pencil type mechanism which advances a length of cosmetic material through tip 3. A number of such advancing mechanisms are known in the art, for example screw type mechanisms or cam type mechanisms.

Handle 1 may comprise a disposable handle which is designed to be discarded following the depletion of the cosmetic material in the applicator 2. Handle 1 may comprise an elongated decorative housing, formed from a plastic, lightweight metal or any other suitable material or materials. Handle 1 comprises a first end 10 adjacent to the applicator and having an opening 11 disposed at said first end . A hollow chamber 12 extends from the opening 11 into the housing. Hollow chamber 12 is adapted and dimensioned to receive and engage a second terminal end of the applicator 2. For example, a second terminal end of applicator 2, opposite an end from which the cosmetic product is dispensed or applied, may be inserted into hollow chamber 12 and held in place by a compression or press fit, or may be secured therein with an appropriate adhesive. In another embodiment, second terminal end of applicator 2 may comprise a male screw thread which is received and engaged by a corresponding female screw thread provided in hollow chamber 12. Applicator 2 is preferably engaged in hollow chamber 12 in a non-rotatable manner.

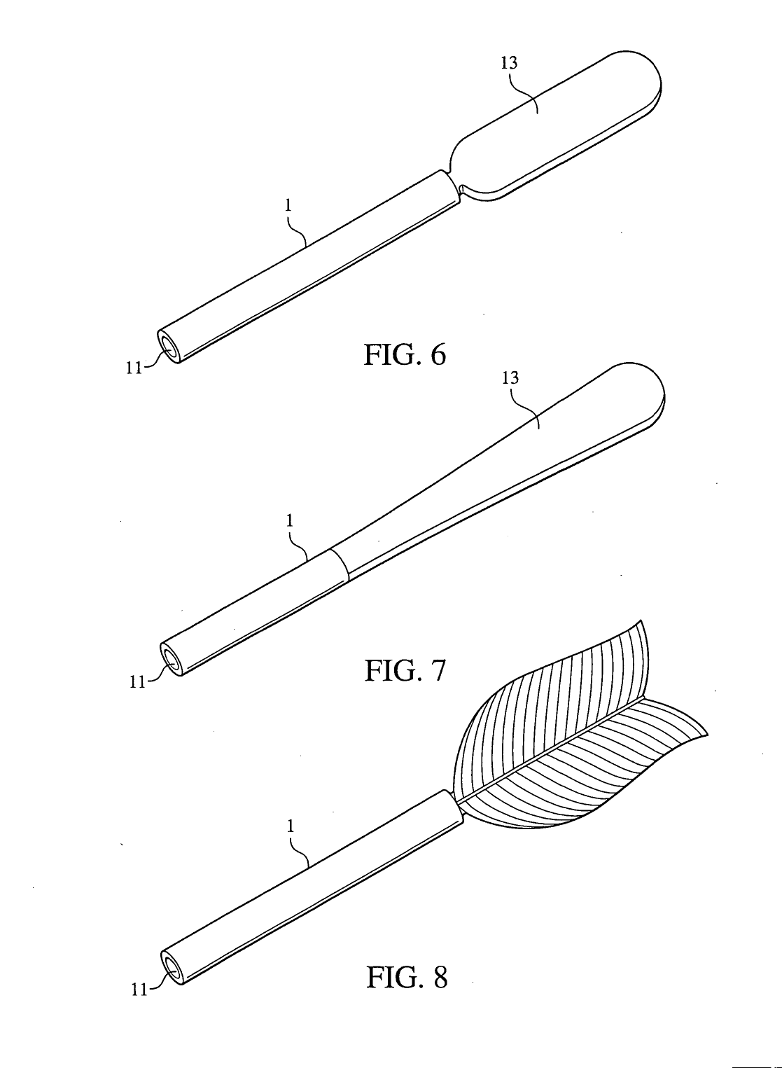

Handle 1 may further comprise a flattened portion 12, as shown in FIGS. 2-7. Flattened portion 13 may be suitable for displaying a word, phrase, symbol or design. For example, various visual indicia may be imprinted or otherwise provided on flattened portion 13. Such indicia may indicate a particular brand, line, type, color, or shade of cosmetic product. Additionally, flattened portion 13 may be used to display a bar code including information about a particular product. The flattened portion 13 of the handle creates a billboard effect allowing persons to easily view the information provided thereon.

As shown in FIGS. 1 and 2, an assembly according to an embodiment of the invention may further include a cover 4. Cover 4 may comprise a rigid tubular element having a first closed end and a second open end. Cover 4 may fit over applicator 2 and engage the first end of the housing.

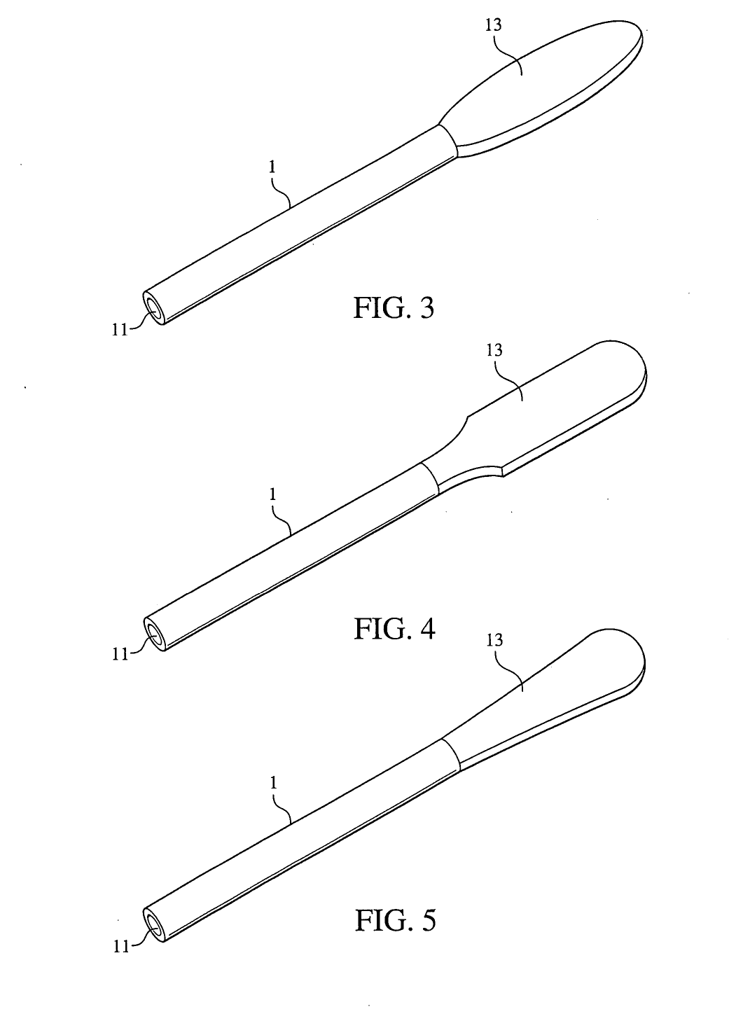

In practice, handle 1 may be selected from a plurality of handles having various designs, shapes, colors and materials or combinations of colors and/or materials. FIGS. 3-8 show a number of exemplary decorative handle designs. Unlike conventional cosmetic applicator handles which are typically straight-sided or have a consistent radius along their length, the handles according to the embodiments of the invention can have a shape which varies along its length. This provides the manufacturer and designer with a wide variety of custom designed handles from which to choose. The distinctive shapes cause the products to stand out in a retail environment. A single applicator design may be compatible with a great variety of handle designs each having a hollow chamber and opening suitable to receive and engage the particular applicator.

Accordingly, while several embodiments of the present invention have been shown and described, it is obvious that many changes and modifications may be made there unto without departing from the spirit and scope of the invention.

What is claimed is:

1. A method for manufacturing a cosmetic product applicator assembly, the method comprising the steps of:
a) selecting a disposable handle having a desired design from a plurality of disposable handles of various designs, each of said plurality of disposable handles comprising an elongated, decorative housing comprising a first end having an opening, a hollow chamber extending from said opening into said housing, and a flattened portion for displaying a word, phrase, symbol or design;
b) inserting a cosmetic product applicator into said handle, said applicator having a first terminal end from which the cosmetic product is dispensed and a second terminal end opposite the first terminal end, wherein said hollow chamber is adapted to receive and engage the second terminal end of the applicator in a non-rotatable manner.

2. A method for manufacturing a cosmetic product applicator assembly, the method comprising the steps of:
a) selecting a handle having a desired design from a plurality of handles of various designs, each of said plurality of handles comprising an elongated, decorative housing comprising a first end having an opening and a hollow chamber extending from said opening into said housing;
b) inserting a cosmetic product applicator into said handle, said applicator having a first terminal end from which the cosmetic product is dispensed and a second terminal end opposite the first terminal end, wherein said hollow chamber is adapted to receive and engage the second terminal end of the applicator.

3. The method according to claim 2, wherein said hollow chamber is further adapted to engage the second terminal end of the applicator in a non-rotatable manner.

4. The method according to claim 2, wherein said step of selecting a handle having a desired design further comprises selecting a handle comprising a flattened portion.

5. The method according to claim 2, wherein said step of inserting a cosmetic product applicator into said handle comprises the step of inserting a cosmetic pencil into said handle.

6. The method according to claim 2, wherein said step of inserting a cosmetic product applicator into said handle comprises the step of inserting a cosmetic brush into said handle.

7. The method according to claim 2 further comprising the step of securing a cover over said cosmetic product applicator, said cover comprising a rigid tubular body having a first closed end and a second end engaging said first end of said housing.

8. A handle for a cosmetic product applicator, the applicator having a first terminal end from which the cosmetic product is dispensed and a second terminal end opposite the first terminal end, the handle comprising:
an elongated, decorative housing comprising a first end having an opening and a hollow chamber extending from said opening into said housing, wherein said hollow chamber is adapted to receive and engage the second terminal end of the applicator, and wherein said housing is produced in a variety of custom designs, each of said designs being compatible with said applicator.

9. The handle for a cosmetic product applicator according to claim 8, wherein said hollow chamber is adapted to engage the second terminal end of the applicator in a non-rotatable manner.

10. The handle for a cosmetic product applicator according to claim 8, wherein said housing further comprises a flattened portion.

11. The handle for a cosmetic product applicator according to claim 10, wherein a word, phrase, symbol or design is displayed on said flattened portion.

12. The handle for a cosmetic product applicator according to claim 8, wherein said handle comprises a disposable handle.
